(19) United States
(12) Patent Application Publication
(10) Pub. No.: US 2010/0186253 A1
(43) Pub. Date: Jul. 29, 2010

(54) METHOD OF DRYING CLOTHING WITH REVERSE CYCLE AND BILLING THEREFOR

(75) Inventor: Dennis Slutsky, Providence, RI (US)

Correspondence Address: WOLF GREENFIELD & SACKS, P.C., 600 ATLANTIC AVENUE, BOSTON, MA, 02210-2206, US

(73) Assignee: American Dryer Corporation, Fall River, MA (US)

(21) Appl. No.: 12/699,089

(22) Filed: Feb. 3, 2010

Related U.S. Application Data
(63) Continuation of application No. 11/838,595, filed on Aug. 14, 2007, now abandoned.
(60) Provisional application No. 60/822,435, filed on Aug. 15, 2006.

(51) Int. Cl. F26B 5/08; F26B 3/02

(52) U.S. Cl. 34/318; 34/499

(57) ABSTRACT

The present invention is a method of drying clothing. A user inserts clothes into a clothes dryer and initiates a normal drying cycle. To initiate a normal drying cycle, the user purchases time for a normal cycle and an optional reverse cycle using a payment interface. The dryer subsequently operates in a normal drying cycle. Next, a reverse drying cycle is initiated, if selected and purchased by the user, to help avoid roping and balling up of their clothes. After the amount of predetermined time purchased for the normal and reverse drying cycles has elapsed, the dryer is turned off. Because a reverse cycle is used, this method of drying clothes prevents roping and balling up of clothes to achieve better drying results in pay operated drying machines.

### CROSS REFERENCE TO RELATED APPLICATION

This application is a continuation application of and claims the benefit under 35 U.S.C. §120 of U.S. application Ser. No. 11/838,595, entitled “METHOD OF DRYING CLOTHING WITH REVERSE CYCLE AND BILLING THEREOF,” filed on Aug. 14, 2007, which is herein incorporated by reference in its entirety.

This application is related to and claims priority from earlier filed provisional patent application Ser. No. 60/822,435, filed Aug. 15, 2006 and incorporated herein by reference.

### BACKGROUND

The present invention generally relates to drying apparatus and methods of operating the same. More specifically, the present invention relates to dryers for drying clothes and methods of operating the same. The present invention further relates to coin-operated (pay for use) clothes dryers and making such apparatus more efficient in operation, easier to use while generating additional revenue for the operator of a laundry facility.

In the prior art, clothes dryers are very well known in the art. In particular, coin-operated or pay for use clothes dryers are commonly used so that a person can use the dryer as needed to obviate the need to own one.

Coin operated clothes dryers are typically located in a “Laundromat” or other similar locations. A typical coin operated dryer is shown in FIG. 1. For use by many customers at the same time, these locations typically house several coin-operated dryer machines, which are typically powered by gas. Other fuels and heat sources can be also be used.

It is well known in the Laundromat and drying industry, that a user employs a dryer by first placing wet clothing into the main basket of the dryer and closes the door. Payment is made for desired amount of drying time by inserting coins into a coin box in the dryer, as is very well known in art, to accumulate drying time. Such a coin box can be either electronic and/or mechanical in construction to accomplish the task of preparing and paying for use of the dryer by the user. Thus, drying time, in general, is paid for by the user. This payment and readying of the dryer can typically be carried out before or after the wet clothes are loaded into the dryer.

When the wet clothes are loaded into the dryer, the drying cycle can begin. This is typically initiated by the user pressing a “start” button, or the like. At this point the heat source of the dryer is turned on and the drying basket, which tumbles the clothes, begins to rotate to dry the clothes. Such heated tumbling continues, typically, for a period of time that has been paid for by the user. It is also possible that this drying cycle can be terminated when the clothes are sensed as being sufficiently dry.

During the aforesaid drying cycle, clothes are subjected to heat and tumbling to effectuate drying. During the course of the drying cycle, the clothes are typically further agitated by vanes that emanate inwardly from the basket to enhance tumbling of the wet clothes therein to avoid “roping” or “balling up” of clothes which prevents heat from contacting all portions of the clothes for effective and complete drying thereof. If clothing experiences roping or balling up, it is often not possible to recover from this condition and the clothes remain roped or balled up for the entire drying cycle regardless of how long the drying cycle is.

This problem is exacerbated in the common situation of where a user buys much more time than is needed to ensure that when they return to the coin-operated laundry facility, their clothes will not be wet and in need of further drying. In this scenario, the outer portion of the clothes are over-dried while the inner portions thereof remain wet. This condition is unacceptable. As a result, there is a need to avoid roping and balling up of wet clothing to ensure an efficient and complete drying cycle.

In the prior art, one way to address the foregoing roping and balling up problem is by reversing the basket of the drying machine to encourage the clothing to stay in a substantially open condition and not rope or ball up. Such a step of reversing the drying basket is generally known in the art, however, this process is not employed in the environment of a coin operated drying machine More specifically, a typical coin operated dryer rotates in a single direction thereby failing to address the roping problem discussed above.

Therefore, there is a specific need to incorporate a reversing basket into coin operated or pay per use drying machines. There is also a need to provide an accounting system to track and receive payment for use of a reversing basket feature. There is a need for a drying machine that enables laundry operators to be able to gain additional revenue if such a reversing operation is employed by the user.

### SUMMARY OF THE INVENTION

The present invention solves the problems associated with prior art clothes dryers and coin-operated laundry facilities. It provides a clothes dryer with an optional reverse drying cycle to avoid roping and balling up of wet clothes during the drying cycle.

The present invention is a method of drying clothing. The method of drying clothing involves providing a dryer, preferably a coin- operated clothes dryer. A typical coin-operated clothes-drying receives coins that triggers a timer to cause the dryer to operate for a predetermined period of time. The dryer contains a heat source in thermal communication with the dryer.

Next, a user inserts clothes into the dryer and initiates a normal drying cycle to reduce the overall moisture within the clothes. To initiate a normal drying cycle, the user purchases a predetermined period of time that is at least one block of time. The dryer subsequently operates in a normal drying cycle.

To help avoid roping and balling up of their clothes to achieve better drying results, a reverse drying cycle is initiated. The reverse drying cycle can be carried out at any point during the duration of the drying and for any given period of time. In addition, a single payment may be used for both the normal drying cycle and the reverse drying cycle.

To initiate a reverse drying cycle, the user purchases a predetermined period of time that is at least one block of time Subsequently, the dryer operates in a reverse drying cycle. It should be noted that there may be more than one reverse cycle. After the amount of predetermined time purchased for both the normal drying cycle and reverse cycle has elapsed, the heat source and the dryer are turned off.

It is therefore an object of the embodiment to provide a method of drying clothing that prevents roping and balling up of clothes.

It is a further object of the embodiment to provide a method of drying clothing that provides a coin-operated clothes which generates more revenues for the laundry operator.

Another object of the embodiment is to provide a method of drying clothing that provides better drying for clothes.

### BRIEF DESCRIPTION OF THE DRAWINGS

The novel features which are characteristic of the method of drying clothing are set forth in the appended claims. However, the method of drying clothing, together with further embodiments and attendant advantages, will be best understood by reference to the following detailed description taken in connection with the accompanying drawings in which:

FIG. 1 is a perspective view of a coin-operated dryer as used in the prior art;

FIG. 2 is a block diagram showing the interaction of component parts in accordance with the present invention; and

FIG. 3 is a flow chart for the method of the present invention for drying clothing that prevents roping and balling up of clothes for a more effective drying.

### DETAILED DESCRIPTION OF THE PREFERRED EMBODIMENTS

The present invention solves the problems associated with prior art methods of drying clothes and, in particular, drying clothes using a dryer. The present invention solves the problems associated with prior art clothes dryers and coin-operated laundry facilities. It provides a new and novel method for drying clothing by providing a clothes dryer 10 with a reverse drying cycle to avoid roping and balling up of wet clothes during the drying of clothes.

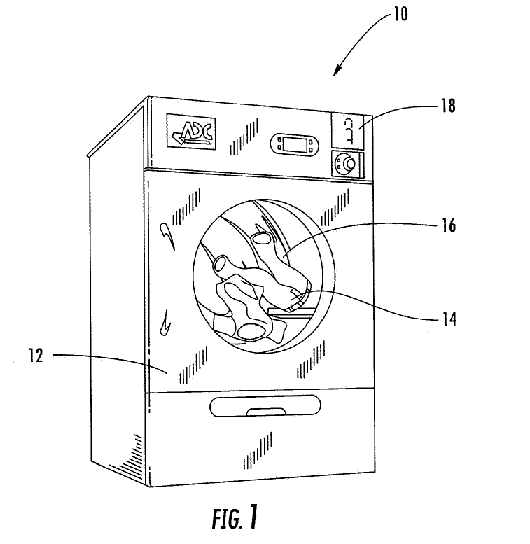

In accordance with the present method for drying clothes, a pay operated, such as a coin-operated, clothes dryer 10 of the type shown in FIG. 1 is provided. The dryer in FIG. 1 is merely an example and any other coin-operated clothes dryer 10 may be used that is capable of drying clothes for a predetermined period of time. The dryer 10 includes a door 12 into which clothes 14 can be loaded into a basket 16. Drying time is purchased by inserting coins (not shown) into a first payment interface 18, such as coin counting device. Payment may also be effectuated by magnetic cards, electronic credit, cell phones or any other method of payment using a payment interface capable of receiving such payment. The operating of such a coin operated dryer 10 is so well known in the art that further discussion is not needed herein.

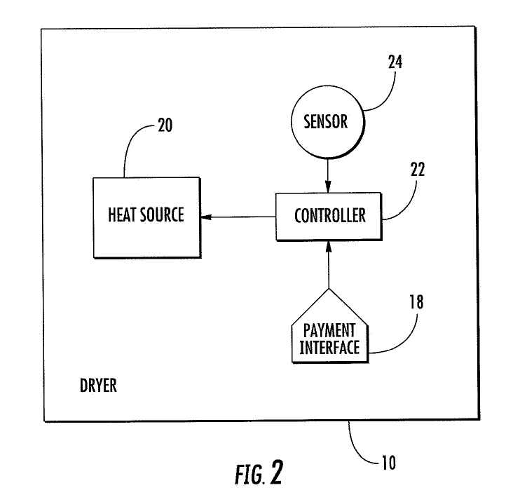

As schematically depicted in FIG. 2, the dryer 10 includes a heat source 24 in thermal connection with the basket 16 of the dryer 10. As can be seen, a controller 22 is employed to control the operation of the delivery of heat within the dryer 10 among other functionality of the dryer 10, such as directional rotation and speed of motor 20 for the basket. The controller 22 can be any type of mechanically or electrical device that can control the functionality of the dryer 10 described herein. Preferably, the controller 22 is a processor located on a circuit board within the dryer 10 with the appropriate software therein. As is well known in the art, such a controller 22 can be programmed in any suitable way to carry out the method of the present invention whereby a reverse drying cycle is initiated to help avoid roping and balling up of clothes.

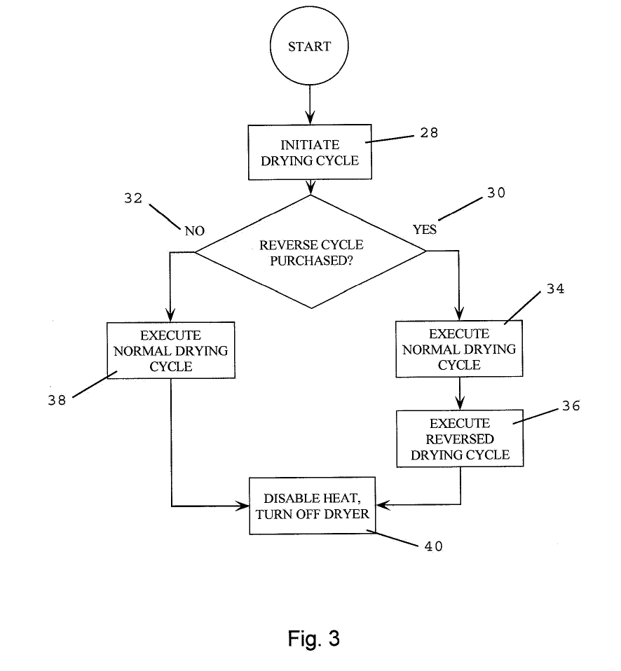

Still referring to FIG. 2, the first payment interface 18 is in electrical communication with the controller 22 to provide information as to the number of blocks of time, and as a result the normal drying cycle time, purchased by the user. The dryer 10 is modified to additionally include a second payment interface 26 for initiating a reverse drying cycle. For example, an additional electronic screen or display page can be added to the coin input display interface and mechanism to accept optional additional payment for adding a reverse cycle. Preferably, a hard button or payment screen selectable button is dedicated for initiating a reverse cycle by which the appropriate funds will be obtained to effectuate that cycle. It is also possible that separate coin slot, screen or payments interface can be provided solely for controlling the use and time of the optional reverse cycle. The reverse drying cycle is employed to control the motor which rotates the basket in a second direction, as will be described in detail below in connection with FIG. 3.

Now referring to FIG. 3, the user inserts clothes 14 into the dryer 10 and the normal drying cycle is initiated at 28 for a predetermined time. To initiate the normal drying cycle 28, the user inserts payment into the payment interface 18 for a block of time or a number of blocks of time. Any type of timer and payment system can be employed to carry out the present invention. For example, the user may insert three quarters to accumulate three blocks of 15 minutes for a total of 45 minutes of drying time into the first payment interface 18. Alternatively, an on/off switch (now shown) may be used in a non-coin operated dryer, which when moved to the “on” position, initiates the normal drying cycle 28.

Once at least one block of time is purchased, the dryer 10 is turned on, the heating source 20, such as a burner, is fired, and the normal drying cycle begins. During operation of the normal drying cycle, the controller 22 directs the motor 20 to rotate the basket 16 in a first direction 34, 38. If no time has been purchased for a reverse drying cycle 32, the normal drying cycle executes 38. When the time purchased for the normal drying cycle expires, without a reverse drying cycle, the heat, motor, and dryer are turned off 40.

To help avoid roping and balling up of clothes to achieve better drying results, the user may purchase additional time for the reverse drying cycle or a the reverse cycle may be purchased for a flat amount. The reverse drying cycle can be carried out any point during the duration of the normal drying cycle and for any given period of time To further explain, the reverse drying cycle may be initiated before, during, or after the normal drying cycle. In addition, the reverse drying cycle may operate without the normal drying cycle. In an alternative embodiment, the reverse drying cycle may alternate between a normal drying cycle and back again during the purchased time.

To purchase the reverse drying cycle, the user purchases a predetermined period of time 30 by inserting payment into the second payment interface 26 for the purchase of blocks of time. A block of time may be purchased in increments similar to the normal drying cycle above. In an alternative embodiment, a single payment may be used for to purchase a block of time for both the normal drying cycle and the reverse drying cycle. Many other options are possible, such as two separate payments, one for the normal cycle and a second for the reverse drying cycle. It is even possible that the second payment for the reverse cycle can be made while the normal cycle is running to add a reverse cycle on the fly.

Once the reverse drying cycle is purchased, the dryer operates in the normal drying cycle in a first direction 34. In one embodiment, the normal drying cycle executes by rotating the basket in a first direction. However, in another embodiment, the normal drying cycle may execute before, during or after the reverse drying cycle. Next, the reverse drying cycle executes 36. During the reverse drying cycle, the basket rotates in a second direction. The second direction of the basket is in the opposite direction of the first direction of the basket. It should also be noted that there may be more than one reverse cycle.

The rotational speed of the basket 16 is determined by the controller 22. The rotational speed in the second direction may be the same or different than the rotational speed in the first direction depending upon the desired effect of preventing the balling or rolling up of the wet clothes.

In an alternative embodiment, the basket 16 may rotate in the first direction before, during, or after it rotates in a second direction. For example, the basket 16 may rotate in the following sequence depending upon the remaining time purchased for the normal drying cycle (first direction) and the reverse drying cycle (second direction): second direction, first direction, second direction, first direction, and finally second direction.

After the amount of predetermined time purchased for both the normal drying cycle has elapsed and reverse drying cycle time has elapsed or the reverse drying cycle has completed, the heat source, motor, and the dryer are turned off 40. Once the dryer is turned off, a user then retrieves the clothes 14 from the clothes dryer 10.

In view of the foregoing, a new and novel method is provided for drying clothes which provides the clothes dryer 10 with the reverse drying cycle. The reverse drying cycle prevents roping and balling up of wet clothing during the drying cycle. The user is billed extra money or credits for use of the reverse cycle, preferably in blocks of time but the user may buy a reverse cycle for a flat amount to have that cycle be executed regardless of time. As a result, the user, at their discretion, can add one or more reverse cycles to their drying cycle to help avoid roping and balling up of their clothes to achieve better drying results. Moreover, the laundry operator will receive additional revenue from the added feature of a reverse drying cycle while providing an overall better drying operation.

It would be appreciated by those skilled in the art that various changes and modifications can be made to the illustrated embodiments without departing from the spirit of the present invention. All such modifications and changes are intended to be covered by the present invention and appended claims.

What is claimed is:

1. A method of drying clothing, comprising the steps of:
providing a dryer with a payment receiving means;
providing a heat source in thermal communication with the dryer; inserting clothes into the dryer;
introducing a first means of payment to the payment receiving means of the dryer for normal drying cycle of clothes;
initiating a normal drying cycle;
operating the dryer in a normal drying cycle;
introducing a second means of payment to the payment receiving means of the dryer for a reverse drying cycle of clothes;
initiating a reverse drying cycle;
operating the dryer in a reverse cycle; and
turning off the heat source and the dryer after the amount of time purchased has elapsed.

2. The method of claim 1, wherein there is more than one reverse drying cycle.

3. The method of claim 1, wherein the first means for payment and the second means for payment are integrated into a single payment by the user.

4. The method of claim 1, wherein the reverse drying cycle is initiated during the normal drying cycle.

5. The method of claim 1, wherein the reverse drying cycle is initiated before the normal drying cycle.

6. The method of claim 1, wherein the reverse drying cycle is initiated after the normal drying cycle.

7. The method of claim 1, wherein the reverse drying cycle is initiated before completion of the normal drying cycle.

8. The method of claim 1, wherein the normal drying cycle is initiated before completion of the reverse drying cycle.

9. The method of claim 1, wherein the reverse drying cycle and normal drying cycle are alternated during operation of the dryer.
